(19) United States
(12) Patent Application Publication
(10) Pub. No.: US 2014/0038548 A1
(43) Pub. Date: Feb. 6, 2014

(54) INFORMATION PROCESSING APPARATUS AND INFORMATION PROCESSING METHOD

(71) Applicant: Fujitsu Mobile Communications Limited, Kawasaki-shi (JP)

(72) Inventors: Hiroto SATO, Tachikawa (JP); Toshiya TAMURA, Kokubunji (JP)

(73) Assignee: Fujitsu Mobile Communications Limited, Kawasaki-shi (JP)

(21) Appl. No.: 13/950,502

(22) Filed: Jul. 25, 2013

(30) Foreign Application Priority Data
Aug. 6, 2012 (JP) 2012-174095

(51) Int. Cl. H04W 4/24

(52) U.S. Cl. CPC H04W 4/24
USPC 455/406

(57) ABSTRACT

An information processing apparatus includes a processor, a storage unit, and a connection unit that connects to a portable device which sends a connection request for a predetermined network as a response to a command from the processor. The processor stores the connection request from the portable device and the predetermined network contained in the connection request in the storage unit; detects a state transition of communication over the predetermined network; and determines whether a network whose status has transitioned from communication being unavailable to communication being available matches the predetermined network stored in the storage unit, and if the two networks match, sends a command to the portable device for causing the portable device to transmit a connection request for the predetermined network as a response.

### CROSS-REFERENCE TO RELATED APPLICATION

This application is based upon and claims the benefit of priority of the prior Japanese Patent Application No. 2012-174095, filed on Aug. 6, 2012, the entire contents of which are incorporated herein by reference.

### FIELD

The present invention relates to an information processing apparatus to which a portable device is connected and which manages communications between the portable device and an external network, an information processing method, and an information processing program.

### BACKGROUND

BIP(Bearer Independent Protocol) is a technique for performing communications between a SIM (Subscriber Identity Module) card and a server in a system including a SIM card, a mobile device to which the SIM card is connected, and a server. BIP is defined by European Telecommunications Standards Institute (ETSI).

According to BIP, the SIM card initiates establishment of a communication channel with a mobile device by sending a request as a response to a command from the mobile device and performs communication with the server through a connection established between the mobile deice and the server. BIP allows the SIM card to add a type of network (or a bearer) to which the mobile device is to be connected as a request parameter. A bearer, meaning carrier or conveyer, can be described as a series of physical or logical paths, for example.

However, a bearer sometimes refers to characteristics of a transported signal. Herein, the term “bearer” will be used in the sense of network type. Network types include a network of Third Generation mobile communications system (hereinafter, referred to simply as “3G network”), a network of a packet communication system, and a wireless LAN(Local Area Network), for example.

In a case where software called a card application is installed in the SIM card, the SIM card controls communications with the mobile device through execution of the card application.

FIG. 1 illustrates an exemplary configuration of a payment system which makes payment by way of networks. The payment system includes a mobile device 1, an IC card 2, a Web server 3, and a payment server 4. The IC card 2 is a SIM card, for example. The IC card 2 is inserted into a slot in the mobile device 1 and electrically connects to the mobile device 1. The mobile device 1 is able to connect to the Internet using a wireless LAN 50 as access network and communicate with the Web server 3 on the Internet. The mobile device 1 is also capable of connecting to a 3G network 60 and communicating with the payment server 4.

The mobile device 1 utilizes connection to the 3G network as a bearer 1 and Internet connection by way of a wireless LAN as a bearer 2. The fee for connecting to the 3G network, or the bearer 1, is charged on a pay-as-you-go basis, for example. The fee for Internet connection by way of the wireless LAN, or the bearer 2, is a flat rate, for example. The user of the mobile device 1 thus usually connects to the wireless LAN, or the bearer 2, and connects to the 3G network, or the bearer 1, when accessing the payment server 4, for example.

The Web server 3 is a server that provides Web pages presenting products of virtual online stores, for example. The Web server 3 is connected with the Internet. The payment server 4 is a server of a credit service provided by a telecommunications carrier for payment processing, for example. The payment server 4 connects to the 3G network, which is a closed network of the telecommunications carrier.

The configuration illustrated in FIG. 1 is a merely an example and is not limitation. For example, the bearers 1 and 2 may be a wireless LAN and WiMAX (Worldwide Interoperability for MicrowaveAccess), respectively. Also, there may be three or more bearers available to the mobile device 1.

FIGS. 2A and 2B are an example sequence of a process relating to payment performed in the network of FIG. 1. In the example of FIGS. 2A and 2B, the mobile device 1 is connected with the Web server 3 by way of the bearer 2(wireless LAN). On the mobile device 1, the bearer 1 (3G network) is connectable. The bearer 1 being connectable refers to when the mobile device 1 is not performing a telephone call or when connectivity to the bearer 1 is enabled by software in the mobile device 1, for example. Hereinbelow, a state in which the mobile device 1 can connect to the bearer 1 will be described as the bearer being “available”. Note that in the example illustrated in FIGS. 2A and 2B, a communication channel has not been established between the mobile device 1 and the IC card 2.

In OP1, the mobile device 1 activates a browser and sends a viewing request for a web page provided by the Web server 3 from the browser by way of the bearer 2 (wireless LAN). In OP2, the Web server 3 sends the requested Web page to the mobile device 1. Upon receiving the web page, the mobile device 1 displays the web page on its screen. The user of the mobile device 1 thereby can see the web page.

In OP3, when the user of the mobile device 1 decides to buy a product displayed on the screen of the mobile device 1, the mobile device 1 sends a purchase request to the Web server 3 in response to, for example, the user's pressing of a button. In OP4, upon receiving the purchase request from the mobile device 1, the Web server 3 sends a payment instruction to a card application for making payment which is incorporated in the IC card 2 inserted into the mobile device 1. Hereinbelow, a function worked out by a processor or the like in the IC card 2 executing an application program will be referred to just as “application”. The payment instruction from the Web server 3 may be sent by way of the bearer 2 as the result of viewing the web page of the Web server 3 or sent to the mobile device 1 by way of SMS(Short Message Service), which is a separate network from the bearer 2. The payment instruction from the Web server 3 may also be sent by electronic mail to the mobile device 1, for example.

In OP5, the mobile device 1, containing the IC card 2, receives the payment instruction from the Web server 3, and includes the payment instruction from the Web server 3 in a predetermined command and sends the command to the card application in the IC card 2.

In OP6, the IC card 2 receives the command from the mobile device 1 and activates the card application. The card application sends a network connection request that specifies the bearer 1 (3G network)to the mobile device 1 as the response to the command received from the mobile device 1 in order to perform communication with the payment server 4.

In OP7, the mobile device 1 takes the connection request from the response received from the card application, sends a connection request to the bearer 1 (3G network) specified in the connection request, and establishes a connection with the bearer 1. Since the bearer 1 is available in the example of FIGS. 2A and 2B, connection is successfully established between the mobile device 1 and the bearer 1.

In OP8, the mobile device 1 includes a notification of “successful connection” in a predetermined command and sends the command to the card application as the result of connection with the bearer 1 specified by the card application. By the card application receiving the command containing the notification of “successful connection”, a communication channel is established between the mobile device 1 and the card application.

In OP9, the card application includes payment information in the response to the command received from the mobile device 1 and sends the response to the mobile device 1 in order to transmit the payment information to the payment server 4. The payment information includes an ID to identify the user of the mobile device 1, an ID for payment such as credit card number, and the like. The payment information may be prestored by the card application (or the IC card 2) in a storage device in the IC card 2, written in the storage device in the IC card 2 in advance by the mobile device 1, or written in the storage device in the IC card 2 in advance from outside (e.g., a server of a telecommunications carrier) by way of a network. For prevention of sniffing on networks, the payment information is transmitted in encrypted form.

In OP10, the mobile device 1 takes the payment information from the response received from the card application and passes it to the payment server 4 via the bearer 1 (3G network). In OP11, the payment server 4 receives the payment information from the mobile device 1, executes a payment approval process if the payment information has no problem, and sends a notification of payment completion to the card application.

In OP12, upon receiving the notification of payment completion from the payment server 4, the mobile device 1 includes a notification of “data transmission completed”, indicating that the payment approval process by the payment server 4 is complete, in a predetermined command and sends the command to the card application. In OP13, the card application receives the command including the notification of “data transmission completed” and recognizes completion of payment, so it sends a request to disconnect the network with the bearer 1 to the mobile device 1 as the response to the command received from the mobile device 1.

In OP14, the mobile device 1 receives the response including the disconnection request for the bearer 1 from the card application, and sends a network disconnection request to the bearer 1 to execute network disconnection. Thereafter, the connection between the bearer 1 and the mobile device 1 is terminated.

In OP15, after disconnection of the network with the bearer 1, the mobile device 1 includes a notification of “successful termination” in a predetermined command and sends the command to the card application as the result of network disconnection. In OP16, upon receiving the command including the notification of “ successful termination” indicating that the network has been disconnected, the card application includes the result of payment in a response to the command containing the result of payment and sends the response to the Web server 3 by way of the bearer 2 (wireless LAN). In OP17, the mobile device 1 takes the result of payment from the response received from the card application and passes it to the Web server 3 via the bearer 2. With this, the Web server 3 recognizes that payment is complete. The result of payment may be provided to the Web server 3 by way of SMS which is a separate network from the bearer 2 or by electronic mail.

[Patent document]

[Patent document 1] Japanese Patent Laid-Open No. 2008-210301

[Patent document 2] Japanese Patent Laid-Open No. 2002-149597

[Patent document 3] Japanese Patent Laid-Open No. 2002-204475

[Patent document 4] Japanese Patent Laid-Open No. 2008-92226

FIG. 3 is a chart illustrating a problem with the system in which a request made by a portable device such as an IC card is sent as the response to a command from a mobile device. FIG. 3 illustrates an example sequence of payment processing. In the example illustrated in FIG. 3, the mobile device 1 has established a connection with the Web server 3 through the bearer 2 (wireless LAN). On the mobile device 1, the bearer 1 (3G network) is unavailable. The bearer 1 being unavailable refers to when the mobile device 1 is performing a telephone call, connectivity to the bearer 1, which charges on a pay-as-you-go basis, is disabled by software in the mobile device 1, when the mobile device 1 is positioned outside the range of the bearer 1, and the like, for example. In other words, the bearer 1 being unavailable represents a state in which it is impossible for the mobile device 1 to perform communication through the bearer 1. As actions at OP21 to OP26 are similar to OP1 to OP6 of FIG. 2A, their detailed descriptions are omitted.

When the user of the mobile device 1 views a web page of the Web server 3 (OP21, OP22) and decides to buy a product (OP23), the Web server 3 sends a payment instruction to an application in the portable device (OP24). The payment instruction from the Web server 3 is included into a predetermined command by the mobile device 1 and sent to the portable device (OP25). The application in the portable device sends a connection request that designates the bearer 1 (3G network) to the mobile device 1 (OP26). The connection request is sent as the response to the command that contains the payment instruction.

In OP27, the mobile device 1 is not able to establish a connection with the bearer 1 (3G network) because the bearer 1 is unavailable, includes a notification of “failed connection” in a predetermined command as the result of connection with the bearer 1, and send the command to the application of the portable device. By receiving the command containing the notification of “failed connection”, the application of the portable device recognizes that connection with the bearer 1 (3G network) has failed.

Suppose that thereafter the state of the mobile device 1 changes and the bearer 1 becomes available, such as the mobile device 1 moving into the range of the bearer 1 (3G network) or connection to the bearer 1 being enabled by software responsive to user operation.

The mobile device 1 is able to detect that the bearer 1 (3G network) has transitioned from unavailable to available. In a system in which a request made by a portable device such as an IC card is sent as the response to a command from a mobile device, however, the portable device such as an IC card is not able to send a network connection request unless it has an opportunity to respond to the command from the mobile device 1. Thus, even when the status of the network specified by an application in the portable device such as an IC card transitions from unavailable to available as illustrated by FIG. 3, the application is not able to connect to the network.

### SUMMARY

According to an aspect of the present invention, there is provided an information processing apparatus. The information processing apparatus includes:
a processor;
a storage unit; and
a connection unit that connects to a portable device which sends a connection request for a predetermined network as a response to a command from the processor,
   wherein
the processor
stores the connection request from the portable device and the predetermined network contained in the connection request in the storage unit;
detects a state transition of communication over the predetermined network; and
determines whether a network whose status has transitioned from communication being unavailable to communication being available matches the predetermined network stored in the storage unit, and if the two networks match, sends a command to the portable device for causing the portable device to transmit a connection request for the predetermined network as a response.

According to another aspect of the invention, there is provided an information processing method to be implemented by the information processing apparatus. Other aspects of the invention may include an information processing program for causing a computer to function as the information processing apparatus, and a non-transitory computer-readable recording medium having recorded therein the information processing program. The non-transitory computer-readable recording medium refers to a recording medium into which information such as data and programs can be stored by electric, magnetic, optical, mechanical, or chemical actions and from which such information can be read by a computer or the like.

The object and advantage of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is an exemplary configuration of a payment system which processes transactions via networks;

FIG. 2A is an exemplary sequence of a process relating to payment;

FIG. 2B is an exemplary sequence of a process relating to payment(continuation);

FIG. 3 is a chart illustrating a problem with the system in which a request made by a portable device such as an IC card is sent as a response to a command from a mobile device;

FIG. 4 is an exemplary hardware configuration of a mobile device;

FIG. 5 is an exemplary hardware configuration of an IC card;

FIG. 6 is a diagram illustrating exemplary functional blocks of the mobile device and IC card;

FIG. 7 is an exemplary flowchart of a process executed by the mobile device;

FIG. 8A is an exemplary sequence of a process of Exemplary operation 1;

FIG. 8B is an exemplary sequence of a process of Exemplary operation 1 (continuation);

FIG. 9A is an exemplary sequence of a process of Exemplary operation 2;

FIG. 9B is an exemplary sequence of a process of Exemplary operation 2 (continuation);

FIG. 10A is an exemplary sequence of a process of Exemplary operation 3; and

FIG. 10B is an exemplary sequence of a process of Exemplary operation 3(continuation).

### DESCRIPTION OF EMBODIMENTS

Embodiments of the present invention will now be described with drawings. Note that the configurations of the embodiments described below are for illustrative purpose and not limitative.

### First Embodiment

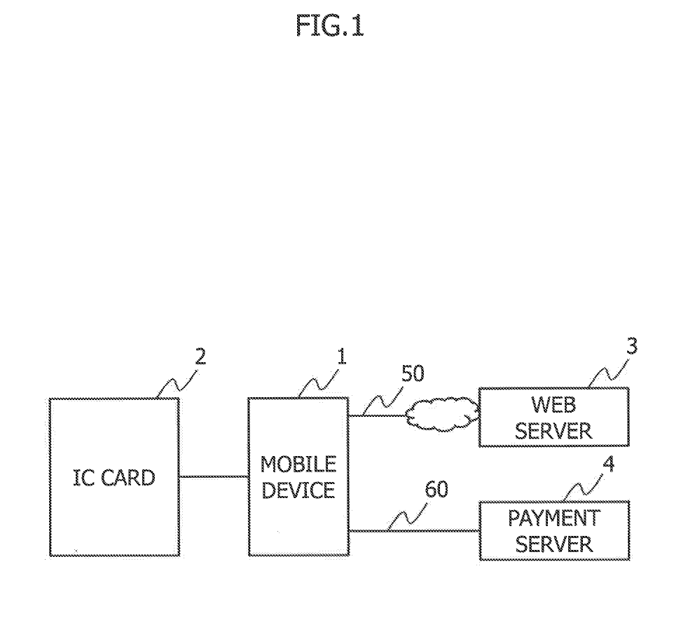

The configuration of a network system according to a first embodiment is similar to that of the network system illustrated in FIG. 1; the network system of the first embodiment includes a mobile device 1, an IC card 2, a Web server 3, and a payment server 4. The IC card 2 is inserted into a slot in the mobile device 1 and is electrically connected with the mobile device 1. The mobile device 1 utilizes a Third Generation mobile device communications network (3G network) as the bearer 1. The mobile device 1 also utilizes a wireless LAN as the bearer 2 and is able to connect to the Internet. The Web server 3 connects to the Internet. The payment server 4 connects to the 3G network. The bearer 1 and the bearer 2 are not limited to a 3G network and a wireless LAN but may be a combination of a wireless LAN and WiMAX, for example. Also, there may be three or more bearers available to the mobile device 1.

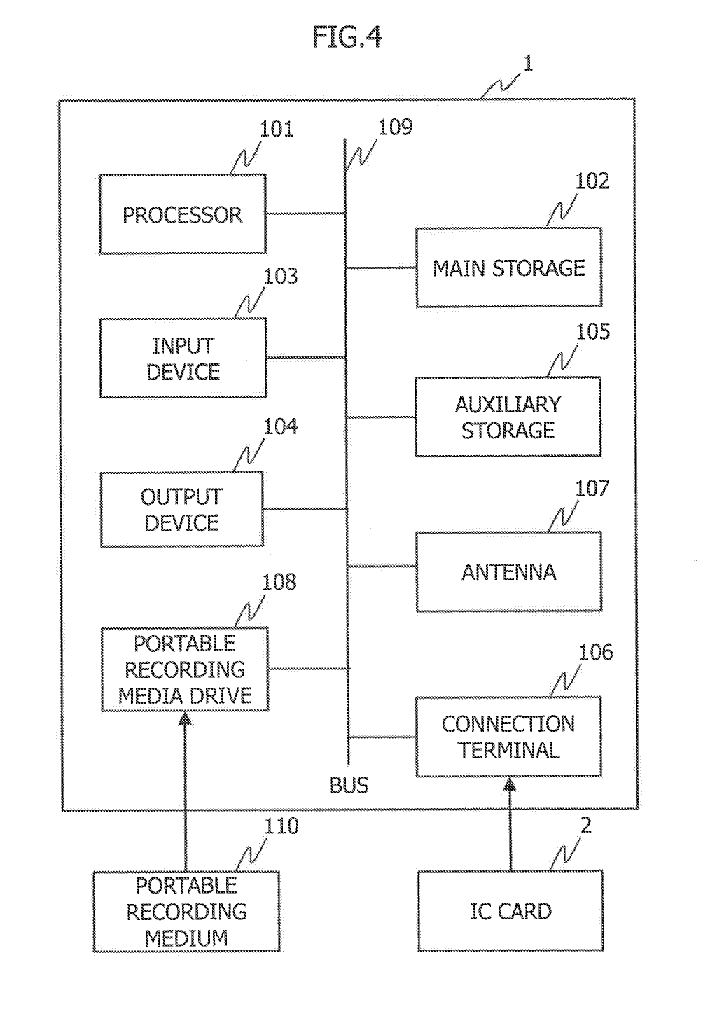

FIG. 4 illustrates an exemplary hardware configuration of the mobile device 1. The mobile device 1 is an information processing apparatus that is electrically connected to an IC card and has wireless communication functions, such as a portable telephone terminal, smartphone, portable information terminal, tablet computer, notebook personal computer, car navigation device, gaming machine with communication functions, for example. The mobile device 1 is an example of the information processing apparatus. However, the information processing apparatus is not limited to the mobile device 1. The information processing apparatus may be stationary as long as it is a device that can be electrically connected with a portable device such as an IC card and has wireless communication functions.

The mobile device 1 includes a processor 101, a main storage 102, an input device 103, an output device 104, an auxiliary storage 105, a connection terminal 106, an antenna 107, and a portable recording media drive 108. These components are interconnected by a bus 109.

The input device 103 may be operation buttons, a touch panel, a keyboard, a keypad, or the like for example. The input device 103 also includes an audio input device, such as a microphone. The input device 103 also includes an image input device, such as a camera. Data input from the input device 103 is output to the processor 101.

The antenna 107 is provided for each bearer type, for example. For example, when the bearer 1 is a 3G network and the bearer 2 is a wireless LAN, an antenna for 3G network and an antenna for wireless LAN are separately provided. Wireless signals received by the antenna 107 are demodulated and decoded into data in a wireless signal processing circuit and output to the processor 101.

The main storage 102 provides the processor 101 with a storage area into which a program stored in the auxiliary storage 105 is loaded and a work area, or is used as a buffer. The main storage 102 is semiconductor memory such as RAM(Random Access Memory), for example.

The auxiliary storage 105 stores programs and data used by the processor 101 for execution of the programs. The auxiliary storage 105 is non-volatile memory such as EPROM(Erasable Programmable ROM) and a hard disk drive(Hard Disk Drive), for example. The auxiliary storage 105 stores an operating system (OS), an information processing program, and various kinds of application program, for example.

The portable recording media drive 108 reads programs and various kinds of data recorded in a portable recording medium 110 and outputs them to the processor 101. The portable recording medium 110 is a recording medium such as an SD card, miniSD card, microSD card, USB (Universal Serial Bus) flash memory, CD (Compact Disc), DVD (Digital Versatile Disc), and flash memory card, for example. By the connection terminal 106 making contact with the connection terminal 204 of the IC card 2, the mobile device 1 and the IC card 2 are electrically connected to each other. The connection terminal 106 is an example of a connection unit.

The processor 101 is a CPU (Central Processing Unit), for example. The processor 101 executes various kinds of processing by loading the OS or various application programs stored in the auxiliary storage 105 or portable recording medium 110 into the main storage 102 and executing them.

The output device 104 outputs the result of processing performed by the processor 101. The output device 104 includes a display and an audio output device such as a speaker. The connection terminal 106 electrically connects the IC card 2.

For example, on the mobile device 1, the processor 101 loads an information processing program stored in the auxiliary storage 105 into the main storage 102 and executes the program. Through execution of the information processing program, the mobile device 1 performs relay of communications between an external network and the IC card 2 and the like.

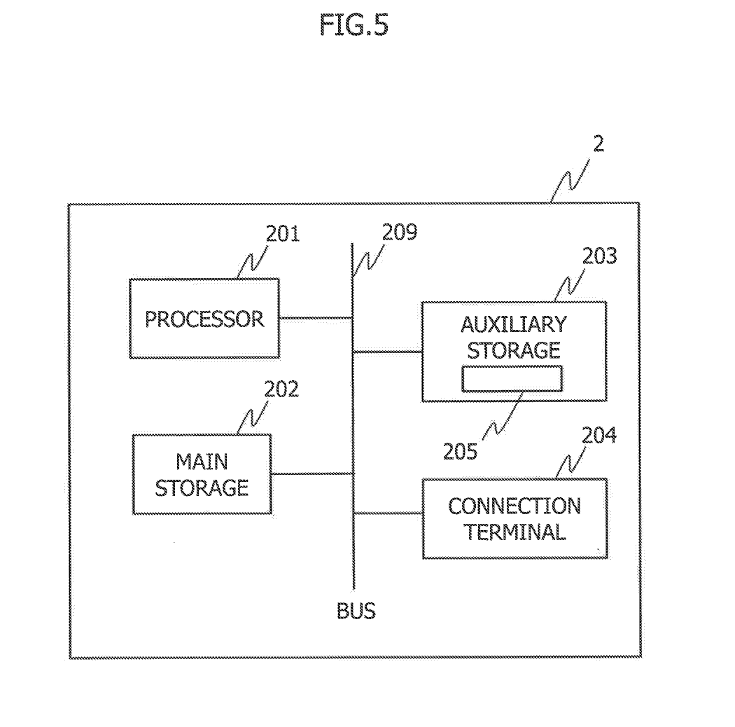

FIG. 5 illustrates an exemplary hardware configuration of the IC card 2. The IC card 2 is an IC card having computation capability, such as a SIM card, for example. The IC card 2 includes a processor 201, a main storage 202, an auxiliary storage 203, and a connection terminal 204. These components are interconnected by a bus 209.

The main storage 202 provides the processor 201 with a storage area into which a program stored in the auxiliary storage 203 is loaded and a work area, or is used as a buffer. The main storage 202 is semiconductor memory such as RAM, for example.

The auxiliary storage 203 stores programs and data used by the processor 201 in execution of the programs. The auxiliary storage 203 is non-volatile memory, including EPROM and ROM, for example. The auxiliary storage 203 stores an OS, card application 205, for example. In the auxiliary storage 203, subscriber information, payment information, and other information are stored. Subscriber information may be identification information of the user of the mobile device 1 which is established at the time of contract with the telecommunications carrier of the 3G network, for example. The payment information includes an ID identifying the user of the mobile device 1, an ID for use in payment such as a credit card number, which are established at the time of contract with an operator providing a payment service, for example. By the connection terminal 204 making contact with the connection terminal 106 of the mobile device 1, the IC card 2 and the mobile device 1 are electrically connected to each other.

The processor 201 is a CPU, for example. The processor 201 executes various kinds of processing by loading an OS and card application 205 stored in the auxiliary storage 203 into the main storage 202 and executing them.

For example, in the IC card 2, the processor 201 loads the card application 205 stored in the auxiliary storage 203 into the main storage 202 and executes it. Through execution of the card application 205, the IC card 2 performs communications with an external network and sends user information for payment processing, for example. The IC card 2 is an example of the portable device; however, the portable device is not limited to an IC card. Another example of the portable device is an SD card with a processor, for example.

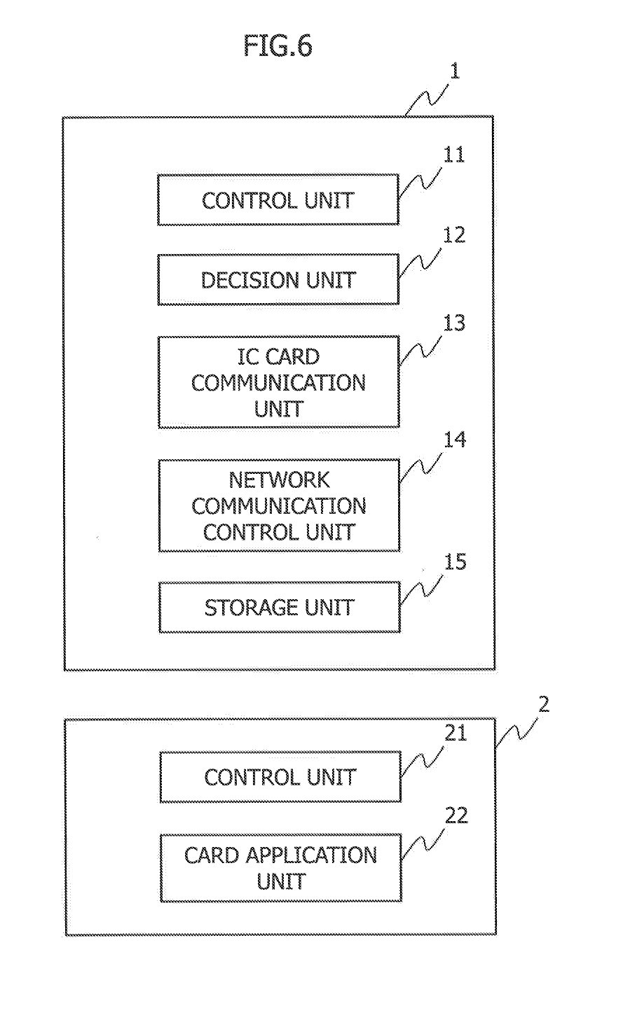

FIG. 6 illustrates exemplary functional blocks of the mobile device 1 and IC card 2. The mobile device 1 executes an information processing program to operate as a control unit 11, a decision unit 12, an IC card communication control unit 13, and a network communication control unit 14. Loading or execution of the information processing program by the mobile device 1 causes a storage unit 15 to be defined in a storage area of the main storage 102 or the auxiliary storage 105. The IC card 2 operates as the control unit 21 by executing an OS. The IC card 2 operates as a card application unit 22 by executing a card application.

The control unit 11 of the mobile device 1 controls processing such as call origination and reception on the mobile device 1, input from the input device 103, and output to the output device 104. For example, when the mobile device 1 originates or receives a call using the bearer 1 (3G network), the control unit 11 retrieves subscriber information from the IC card 2 by way of the IC card communication control unit 13 and performs processing relating to call origination or reception.

The control unit 11 also relays data between a bearer via the network communication control unit 14 and the IC card 2 via the IC card communication control unit 13, for example. For example, the control unit 11 analyzes data obtained by way of the bearer 1 (3G network) or bearer 2 (wireless LAN), and passes the data to the IC card 2 via the IC card communication control unit 13 when the data is destined for the card application unit 22 of the IC card 2. The control unit 11 also instructs the network communication control unit 14 to connect to a specified bearer in response to a connection request containing a specified bearer made by the card application unit 22 of the IC card 2 via the IC card communication control unit 13, for example.

The IC card communication control unit 13 controls communication between the IC card 2 and the mobile device 1. For example, the IC card communication control unit 13 reads subscriber information stored in the IC card 2 and relays communications between the IC card 2 and the control unit 11.

The network communication control unit 14 controls connection to multiple bearers available to the mobile device 1. The network communication control unit 14 also detects state transitions of communications over the bearers. For example, the network communication control unit 14 detects state transitions of communications over the bearers by periodically determining availability and connection status (i.e., connected or disconnected) of the individual bearers. The network communication control unit 14 also detects state transitions of communications over the bearers from a software-based change of connectivity settings for the bearers or reception of a predetermined signal from outside, for example. When it detects a state transition of communication over a bearer, the network communication control unit 14 notifies the control unit 11 of the state transition.

For the first embodiment, suppose that the mobile device 1 can utilize a 3G network through registration with a base station as long as the mobile device 1 is able to perform connection and data transmission/reception (a so-called “within range”) when it wants to do so. Suppose also that the mobile device 1 is not able to utilize a 3G network when it is not registered with a base station and is so-called “out of range”. Suppose also that the mobile device 1 can utilize a wireless LAN when it has established a connection with an access point or an ad-hoc connection point and is not able to utilize a wireless LAN when it has failed to establish a connection. It is assumed however that for all of the networks, when connectivity to a network is set to disabled by software, the mobile device 1 is not able to utilize the network.

When there is an instruction for connection request from the control unit 11, the network communication control unit 14 performs a connection establishment process if the bearer specified in the connection request has been detected to be available. When a connection with the specified bearer is successfully established as the result of the connection establishment process, the network communication control unit 14 sends a notification of successful connection to the control unit 11. When the bearer specified in the connection request has been detected to be unavailable, the network communication control unit 14 sends a notification of failed connection to the control unit 11 without performing a connection establishment process. The notification of successful connection or failed connection sent to the control unit 11 is included into a predetermined command and sent to the IC card 2 via the IC card communication control unit 13 by the control unit 11.

For example, when connectivity to the 3G network is enabled by software, the network communication control unit 14 detects a base station by detecting a wireless signal and registers the mobile device 1 with the base station so that packet data communication can be performed. This causes the state of the 3G network to be detected as available by the network communication control unit 14. At this stage, the network communication control unit 14 retrieves subscriber information from the IC card 2 via the IC card communication control unit 13 and control unit 11 and sends the subscriber information to the base station along with registration of the mobile device 1.

The decision unit 12 monitors relay process performed by the control unit 11 for communication between the IC card 2 and a bearer (i.e., data relay process between the network communication control unit 14 and the IC card communication control unit 13). For example, the decision unit 12 recognizes that communication between the mobile device 1 and the IC card 2 has started by detecting data relay process by the control unit 11 from the network communication control unit 14 to the IC card communication control unit 13 or responsive to an instruction from the control unit 11, and starts monitoring of the control unit 11.

When detecting that the control unit 11 has received a network connection request made by the IC card 2 from the IC card communication control unit 13, the decision unit 12 stores the connection request and the bearer specified in the connection request in, for example, the storage unit 15. Alternatively, the connection request and the bearer specified in the connection request may be instead stored in a storage area of the main storage 102 or auxiliary storage 105 prepared for the decision unit 12.

When detecting that the control unit 11 has received a state transition of communication over a bearer from the network communication control unit 14, the decision unit 12 compares the specified bearer stored in the storage unit 15 with the bearer whose status has transitioned. If the specified bearer stored in the storage unit 15 matches the bearer whose status has transitioned and the control unit 11 is notified that the state of communication over the bearer has become available, the decision unit 12 sends a command to the IC card 2 via the IC card communication control unit 13. The command sent here is for causing the IC card 2 to send a connection request as the response to the command. The command sent to the IC card 2 may be a command not relevant to the card application unit 22 currently activated. For example, it may be STATUS command for acquiring the state of the IC card 2, Channel Status Envelop command for indicating the bearer status, or the like. In addition, the state of the specified bearer (i.e., available) may be included in the command. By including the state of the specified bearer in the command, load of processing for deciding the specified bearer in the IC card 2 can be lessened.

When detecting that the control unit 11 has received a network disconnection request made by the IC card 2 from the IC card communication control unit 13, the decision unit 12 deletes information on the connection request and the specified bearer stored in the storage unit 15.

The user can disable connection to the bearer 1 (3G network), which is charges on a pay-as-you-go basis, for the purpose of saving communication cost, for example. When connection to the bearer 1 is disabled by the user (software), the decision unit 12 may provide a notification of enablement of connection to the bearer 1 upon receiving a connection request for the bearer 1 from the card application unit 22 for payment processing for the IC card 2. For example, when the decision unit 12 detects that a connection request for the bearer 1 has been received by the control unit 11 from the IC card 2, the decision unit 12 has the display of the mobile device 1 present a screen for confirming enablement of the bearer 1. If the user inputs permission for enabling the bearer 1, the decision unit 12 instructs the network communication control unit 14 to execute a connection establishment process to the bearer 1. Also, in this case, the decision unit 12 may set connectivity to the bearer 1 back to disabled when it detects that a disconnection request has been received from the IC card 2 and connection with the bearer 1 has been terminated.

The control unit 21 of the IC card 2 proceeds to activate a card application unit 22 and relay data between the card application unit 22 and the mobile device 1. When receiving a command destined for an unactivated card application from the mobile device 1, the control unit 21 of the IC card 2 identifies the card application specified in the command and activates the appropriate card application unit 22. In the first embodiment, the card application unit 22 is a functional block of a card application for payment processing. As the data relay process between the mobile device 1 and the card application unit 22, the control unit 21 takes information indicating payment instruction, successful connection, failed connection or the like from a command received from the device 1, and sends a payment instruction to the card application unit 22, for example. Also, upon receiving a connection request or information such as payment information from the card application unit 22, the control unit 21 sends it to the mobile device 1 as the response to the command, for example. For example, the control unit 21 includes the connection request or information such as payment information into the payload portion of the response to the command.

The card application unit 22 sends a connection request via the control unit 21 in response to the payment instruction given by the mobile device 1 via the control unit 21. The connection request contains information on the bearer specified for use by the card application unit 22. The card application unit 22 maintains predefined information on the bearer to be used. The IC card 2 designates a 3G network, wireless LAN, circuit switching network, GPRS(General Packet Radio Service), UTRAN(Universal Terrestrial Radio Access), E-UTRAN(Evolved UTRAN), I-WLAN(Interworking WLAN), or the like, for example, as the bearer specified in connection requests.

When receiving a notification of successful connection from the mobile device 1 via the control unit 21, the card application unit 22 reads payment information from the auxiliary storage 203 and sends it via the control unit 21. When receiving a notification of failed connection from the mobile device 1 via the control unit 21, the card application unit 22 may continue the session with the mobile device 1 for a predetermined period of time or disconnect the session. For example, when a notification of failed connection is received from the mobile device 1 and thereafter a command destined for the card application unit 22 is received from the mobile device 1 while the session with the mobile device 1 is maintained, the card application unit 22 sends a connection request via the control unit 21. The connection request sent here also contains designation of the bearer to be used.

### Process Flow for Mobile Device

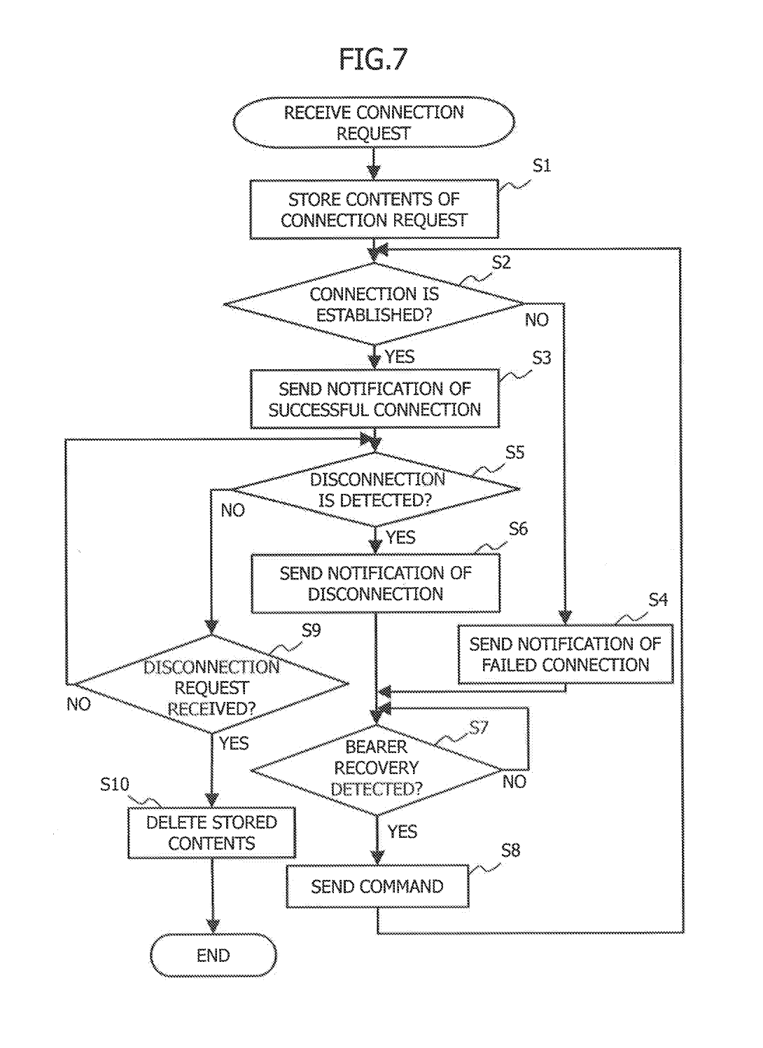

FIG. 7 is an exemplary flowchart of a process executed by the mobile device 1. The process of the flowchart illustrated in FIG. 7 is started when the mobile device 1 receives a connection request from the IC card 2.

In S1, the processor 101 stores the contents of the detected connection request from the IC card 2 in the storage unit 15. Specifically, the processor 101 stores the connection request from the IC card 2 and the bearer specified in the connection request. The action at 51 represents one of actions of the decision unit 12. The flow then proceeds to S2.

In S2, the processor 101 determines whether connection to the bearer specified in the connection request has been successfully established. If connection to the bearer specified in the connection request has been successfully established (S2: Yes), the flow proceeds to S3. If connection to the bearer specified in the connection request has failed (S2: No), the flow proceeds to S4. Detection of a successful connection establishment with the bearer specified in the connection request represents one of actions of the network communication control unit 14.

In S3, as connection with the bearer specified in a connection request has been established, the processor 101 includes a notification of “successful connection” in a predetermined command and sends the command to the IC card 2. The action at S3 represents one of actions of the control unit 11. The flow then proceeds to S5.

In S4, as establishment of connection with the bearer specified in the connection request has failed, the processor 101 includes a notification of “failed connection” in a predetermined command and sends the command to the IC card 2. The action at S4 represents one of actions of the control unit 11. The flow then proceeds to S7.

In S5, the processor 101 determines whether it has detected termination of the connection with the specified bearer that has been taking place. Termination of a connection with the specified bearer that has been taking place can be detected by detecting a change in reception status of wireless signals of the specified bearer, for example. If termination of the connection with the specified bearer that has been taking place is detected (S5: Yes), the flow proceeds to S6. If termination of the connection with the specified bearer that has been taking place is not detected (S5: No), the flow proceeds to S9. The action at S5 represents one of actions of the network communication control unit 14.

In S6, the processor 101 includes a notification of “specified bearer disconnected” indicating that connection with the bearer specified in the connection request has been terminated in a predetermined command and sends the command to the IC card 2. The action at S6 represents one of actions of the control unit 11. The flow then proceeds to S7.

In S7, the processor 101 detects that the state of a bearer has transitioned from unavailable to available and determines whether that bearer is the specified bearer stored in the storage unit 15. Transition of the bearer state from unavailable to available is referred to as bearer recovery. Detection of bearer recovery represents one of actions performed by the network communication control unit 14. Determination of whether a recovered bearer is the bearer specified in a connection request represents one of actions of the decision unit 12. Determination of whether a recovered bearer is the bearer specified in a connection request is done by comparing the recovered bearer with the bearer specified in the connection request which is stored in the storage unit 15. If recovery of the bearer specified in the connection request is detected (S7: Yes), the flow proceeds to S8.

In S8, as recovery of the bearer specified in the connection request has been detected, the processor 101 sends a command to the IC card 2 in order to prompt the IC card 2 to transmit a connection request. The command may contain the state of the specified bearer. The action at S8 represents one of actions of the decision unit 12. The flow then returns to S2 and steps S2 through S7 are repeatedly executed.

In the processing at S8, if the session with the IC card 2 is being maintained, the processor 101 sends a command. If the session with the IC card 2 has been disconnected, the processor 101 includes a predetermined instruction in a command and sends the command, for example. For example, in a case where the card application unit 22 is a card application relating to payment processing, the predetermined instruction contained in the command is a payment instruction.

Also in the processing at S8, the processor 101 may include information on the specified bearer, which is now available, in the command to be sent to the IC card 2. By including information on the specified bearer in the command to be sent to the IC card 2, load of processing for deciding the specified bearer in the card application unit 22 of the IC card 2 can be lessened.

In S9, the processor 101 determines whether a disconnection request has been received from the IC card 2. If the processor 101 receives a disconnection request from the IC card 2 (S9: Yes), the flow proceeds to S10. If the processor 101 does not receive a disconnection request from the IC card 2 (S9: No), the flow returns to S5, where steps S5 and S9 are repeated until a disconnection request is received from the IC card 2. Reception of a disconnection request from the IC card 2 represents one of actions performed by the IC card communication control unit 13. Detecting reception of a disconnection request from the IC card 2 is one of actions performed by the control unit 11.

In S10, the processor 101 deletes the connection request and the bearer specified in the connection request stored in the storage unit 15. The action at S10 is one of actions of the decision unit 12. Thereafter, the processor 101 performs processing for terminating the connection with the bearer specified in the connection request, upon which the process illustrated in FIG. 7 ends.

Processing performed by the mobile device 1 is not limited to the process of the flowchart illustrated in FIG. 7. For example, the timing of storing a connection request from the IC card 2 and the timing of deleting the stored connection request may be varied as appropriate.

### Exemplary Operation 1

Exemplary operation 1 describes operations of the mobile device 1 and IC card 2 for a case where the bearer specified in a connection request by a card application in the IC card 2 is unavailable at the time of the connection request and afterwards transitions to become available.

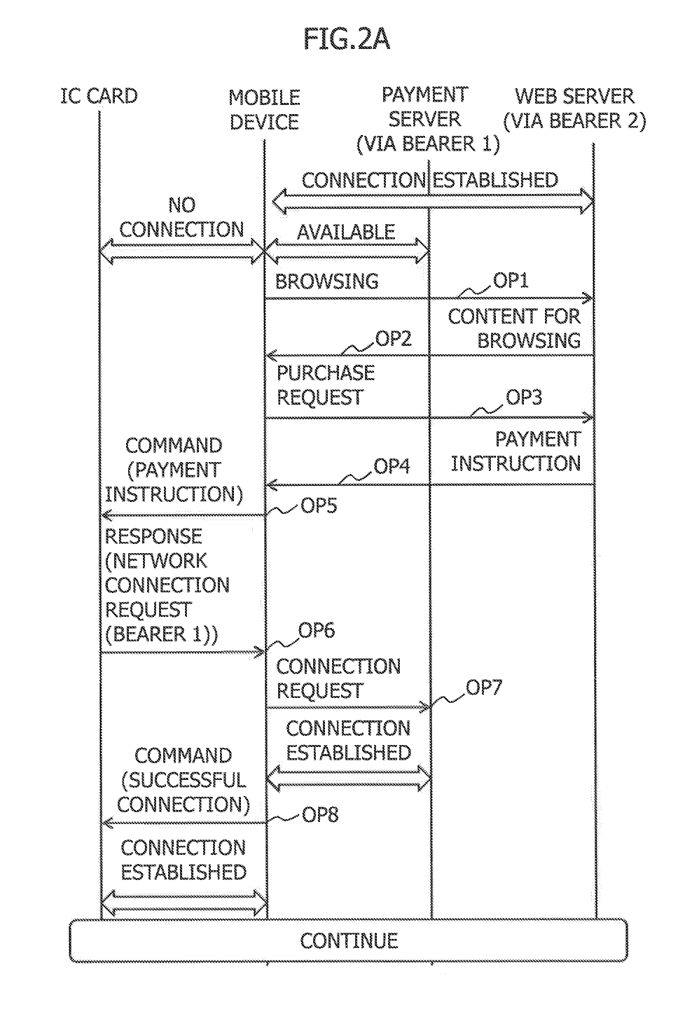

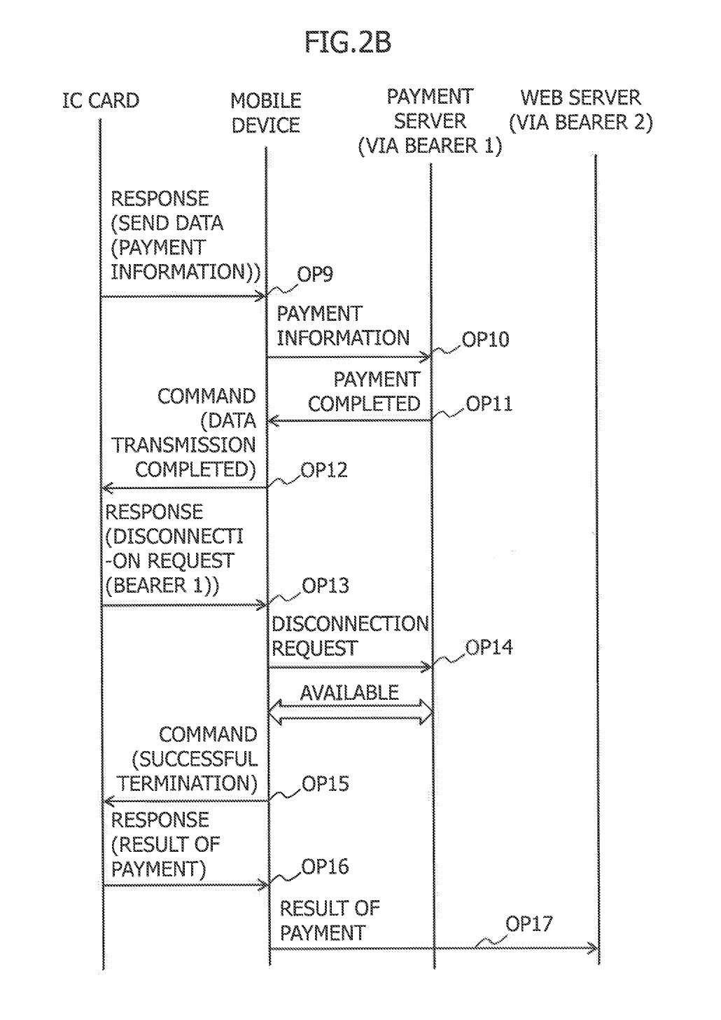

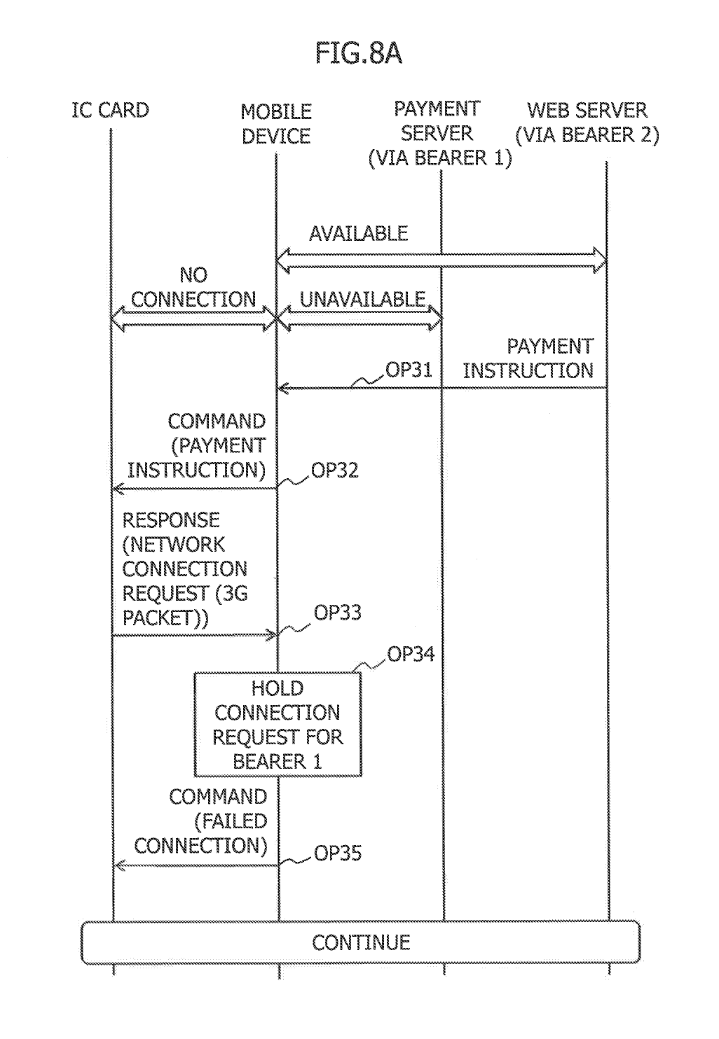

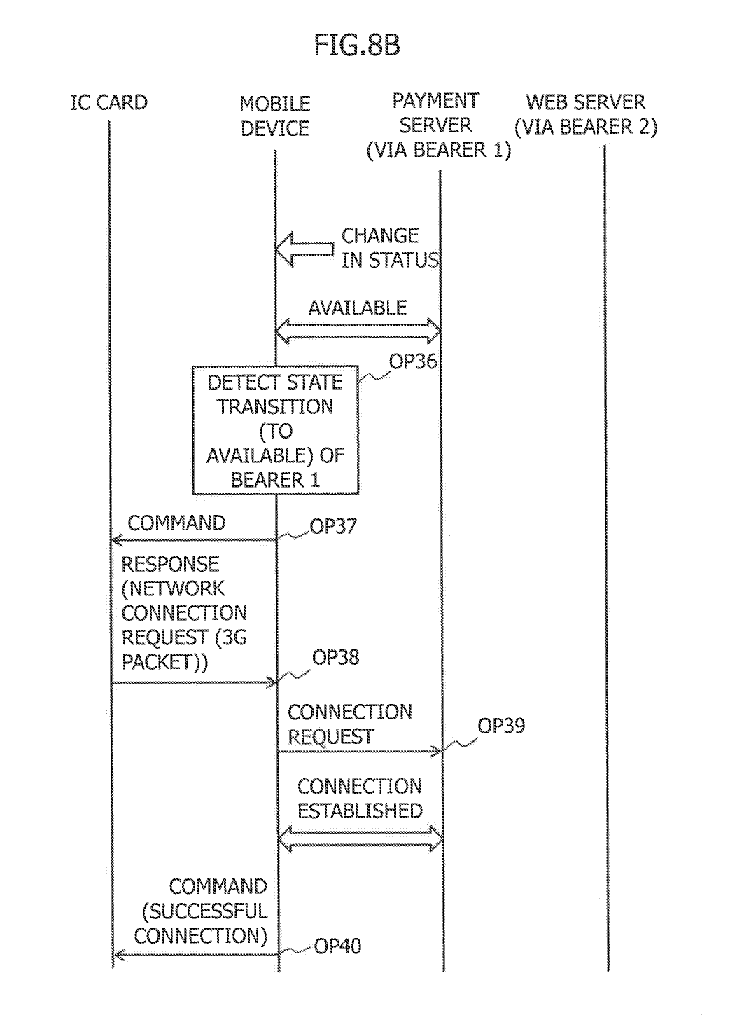

FIGS. 8A and 8B are an exemplary sequence of a process of Exemplary operation 1. The example of FIGS. 8A and 8B correspond to the network system illustrated in FIG. 1, where the IC card 2 specifies the bearer 1 as the network to connect to. In the example of FIGS. 8A and 8B, the mobile device 1 performs payment processing for purchase of a product provided by the Web server 3, as in the case illustrated in FIGS. 2A and 2B, for example. In the example of FIGS. 8A and 8B, the bearer 1 (3G network) is unavailable, because of its connectivity being disabled by software or the mobile device 1 being located out of range. The bearer 2 (wireless LAN) is available. The mobile device 1 has detected these states of the bearer 1 and bearer 2. FIG. 8A omits actions relating to viewing of web pages from the mobile device 1 to the Web server 3, such as actions related to OP1 through OP3 in FIG. 2A.

In OP31, the mobile device 1 receives a payment instruction destined for the IC card 2 from the Web server 3. In OP32, the mobile device 1 includes the received payment instruction in a predetermined command and sends the command to the IC card 2. At this point, the decision unit 12 of the mobile device 1 starts monitoring of processing by the control unit 11.

In the IC card 2, when the predetermined command containing the payment instruction is received from the mobile device 1, the control unit 21 takes the payment instruction from the command, activates a card application unit 22 relating to payment processing, and sends the payment instruction to the card application unit 22.

In OP33, the card application unit 22 of the IC card 2 sends a network connection request that specifies the bearer 1 (3G network). The network connection request is sent to the mobile device 1 by the control unit 21 of the IC card 2 as the response to the command received in OP32.

In OP34, the mobile device 1 receives the response containing the network connection request specifying the bearer 1 (3G network), and stores the connection request and the bearer specified in the connection request (bearer 1) (S1 in FIG. 7).

In OP35, the mobile device 1 does not perform a connection establishment process by the network communication control unit 14 because it has been detected that the bearer 1 is unavailable (S2 in FIG. 7: No). The mobile device 1 sends a command containing a notification of failed connection with the bearer 1 to the IC card 2 through the control unit 11 (S4 in FIG. 7).

Suppose that thereafter the state of the bearer 1 transitions to available as a result of the connectivity to the bearer 1 (3G network) being changed to enabled by software, or the mobile device 1 moving into the range, for example.

In OP 36, the mobile device 1 detects through the network communication control unit 14 that the state of the bearer 1 (3G network) has transitioned from unavailable to available (S7 in FIG. 7: Yes). Here, the decision unit 12 of the mobile device 1 compares the specified bearer stored in the storage unit 15 with the bearer detected to have recovered by the network communication control unit 14, and determines that they match.

In OP37, the mobile device 1 sends a predetermined command to the IC card 2 through the decision unit 12 because the specified bearer stored in the storage unit 15 and the bearer detected to have recovered by the network communication control unit 14 are both the bearer 1 (S8 in FIG. 7). If the session with the card application unit 22 of the IC card 2 is maintained at this point, the decision unit 12 sends an empty command, for example. If the session with the card application unit 22 of the IC card 2 has been disconnected, the decision unit 12 sends a payment instruction in the predetermined command, for example.

In OP38, the IC card 2 receives the predetermined command from the mobile device 1. When the card application unit 22 is activated, the card application unit 22 receives the predetermined command. If the card application unit 22 is not activated, the control unit 21 takes the payment instruction from the command, activates the card application unit 22, and sends the payment instruction to it. The IC card 2 sends through the card application unit 22 a network connection request that specifies the bearer 1 (3G network) as the response to the received command.

In OP39, the mobile device 1 receives the response containing the network connection request specifying the bearer 1 (3G network). As the bearer 1 is now available, the mobile device 1 executes a connection establishment process with the bearer 1 through the network communication control unit 14. Thereafter, connection with the bearer 1 succeeds, establishing a connection between the bearer 1 and the mobile device 1 (S2 in FIG. 7: Yes).

In OP40, the mobile device 1 sends a notification of “successful connection” in a predetermined command to the IC card 2 (S3 in FIG. 7). Thereafter, processing related to payment is executed in a similar manner to OP9 to OP17 of the example illustrated in FIGS. 2A and 2B. When the payment-related processing ends and a disconnection request is received from the IC card 2, the mobile device 1 deletes the connection request and the specified bearer stored in the storage unit 15.

In a case where the specified bearer is unavailable when a connection request from the IC card 2 is received and recovers afterwards as in Exemplary operation 1, the mobile device 1 sends a predetermined command to the IC card 2 to allow the IC card 2 to re-transmit the connection request.

### Exemplary Operation 2

Exemplary operation 2 describes operations of the mobile device 1 and IC card 2 in a case where the bearer specified by the IC card 2 in a connection request transitions to unavailable during connection establishment process to the bearer and connection with the bearer fails, and the bearer recovers afterwards.

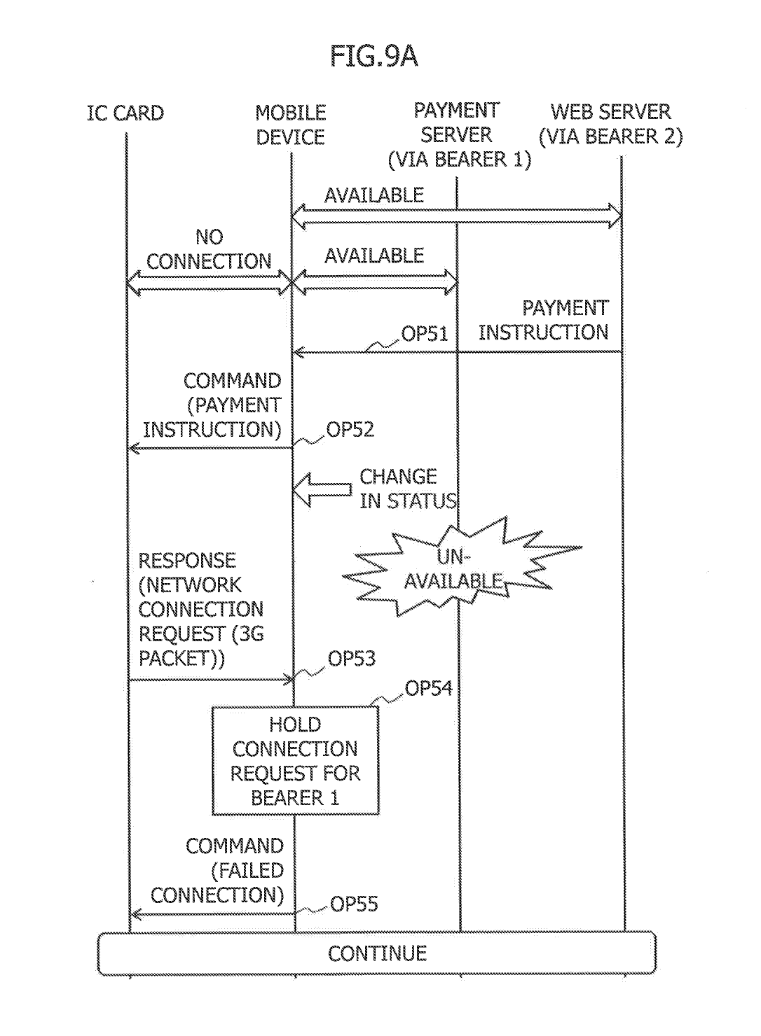

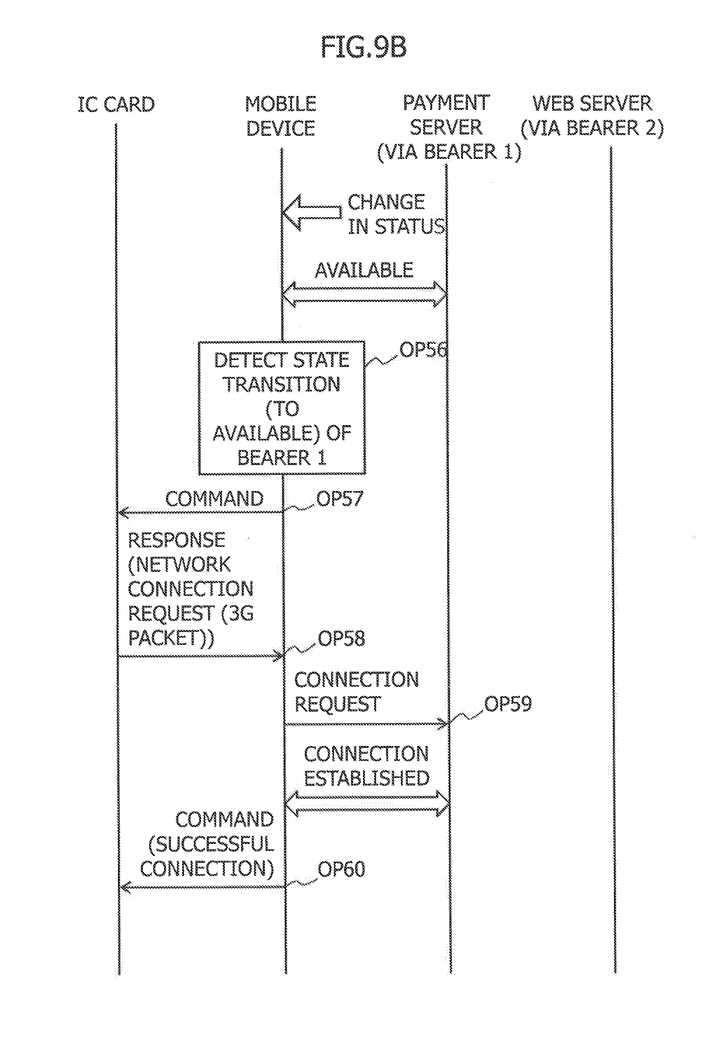

FIGS. 9A and 9B are an exemplary sequence of a process in Exemplary operation 2. The example illustrated in FIGS. 9A and 9B corresponds to the network system illustrated in FIG. 1, where the IC card 2 specifies in a connection request the bearer 1 as the network to connect to. FIGS. 9A and 9B illustrate a case where the mobile device 1 performs payment processing for purchase of a product provided by the Web server 3, as in the example illustrated in FIGS. 2A and 2B. In the example illustrated in FIGS. 9A and 9B, the bearer 1 (3G network) and the bearer 2 (wireless LAN) are both available. The mobile device 1 has detected these states of the bearer 1 and the bearer 2. FIG. 9A omits actions relating to viewing of web pages from the mobile device 1 to the Web server 3, such as actions related to OP1 through OP3 in FIG. 2A. As actions at OP51 to OP54 of FIG. 9A are similar to OP31 to OP34 of Exemplary operation 1 illustrated in FIG. 8A, their descriptions are omitted.

Exemplary operation 2 assumes that after the mobile device 1 sends a command containing a payment instruction to the IC card 2 in OP 52, the bearer specified in the connection request (bearer 1) by the IC card 2 transitions to unavailable as a result of, for example, the mobile device 1 moving outside the range (such as a tunnel). However, because the IC card 2 does not detect that the bearer specified in the connection request (bearer 1) has transitioned to unavailable, the IC card 2 sends a connection request specifying the bearer 1 as the response to the command containing the payment instruction from the mobile device 1 to the mobile device 1 in OP53.

In OP54, the mobile device 1 receives the connection request from the IC card 2, and stores the connection request and the specified bearer (bearer 1) in the storage unit 15 (S1 in FIG. 7). Since the bearer 1 has transitioned to unavailable, connection to the bearer 1 fails (S2 in FIG. 7: No). In OP55, the mobile device 1 sends a notification of failed connection in a predetermined command to the IC card 2 (S4 in FIG. 7). The mobile device 1 has detected the transition of the bearer 1 (3G network) to unavailable through, for example, periodical detection of network status by the network communication control unit 14, and decides failed connection without executing a connection establishment process to the bearer 1. Alternatively, the mobile device 1 may actually execute connection establishment process to the bearer 1 through the network communication control unit 14 and decide failed connection as the result of the execution.

Suppose that subsequently the bearer (3G network) transitions from unavailable to available as the mobile device 1 moves from outside to inside the range such as coming out of a tunnel, for example. In OP56, the mobile device 1 detects recovery of the bearer 1 (3G network) through the network communication control unit 14 (S7 in FIG. 7: Yes). Here, the decision unit 12 of the mobile device 1 compares the specified bearer stored in the storage unit 15 with the bearer that is detected to have recovered by the network communication control unit 14, and determines that they match.

In OP57, the mobile device 1 sends a predetermined command to the IC card 2 through the decision unit 12 because the specified bearer stored in the storage unit 15 and the bearer detected to have recovered by the network communication control unit 14 are both the bearer 1 (S8 in FIG. 7). The state of the specified bearer (i.e., available) may be included in the predetermined command.

The IC card 2 receives the predetermined command from the mobile device 1. In OP58, the IC card 2 sends through the card application unit 22 a network connection request that specifies the bearer 1 (3G network) as the response to the received command.

Thereafter, a connection is established between the mobile device 1 and the bearer 1 (S2 in FIG. 7: Yes) and a connection between the mobile device 1 and the IC card 2 is established, and communication is performed between the IC card 2 and the payment server 4, as in OP7 and the following operations in FIG. 2B and OP38 and the following operations in FIG. 8B.

In the first embodiment, the mobile device 1 sends a predetermined command to the IC card 2 even when the specified bearer becomes unavailable during connection establishment process from the mobile device 1 to the specified bearer and connection fails once, and the bearer recovers later, as in Exemplary operation 2. The first embodiment therefore enables the IC card 2 to retransmit a connection request and connect to the specified bearer even in such a case illustrated by Exemplary operation 2.

### Exemplary Operation 3

Exemplary operation 3 describes operations of the mobile device 1 and the IC card 2 for a case where a connection is terminated due to transition of the specified bearer's state to unavailable while communication is performed by the IC card 2 using the specified bearer and the bearer recovers again.

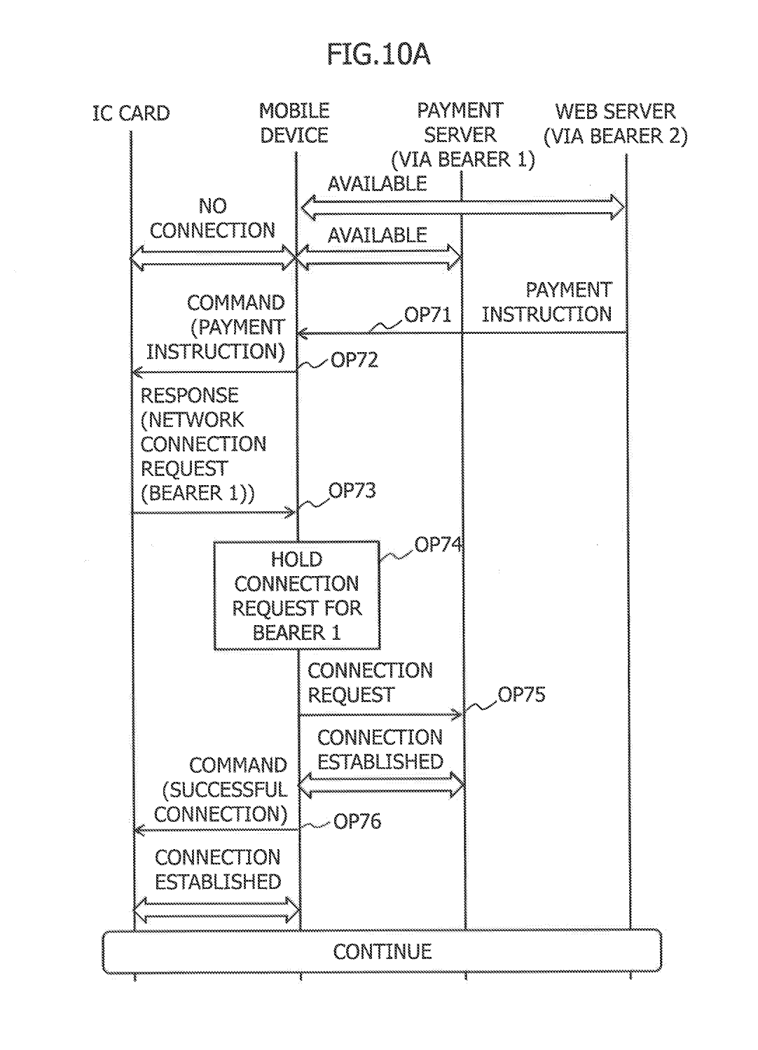

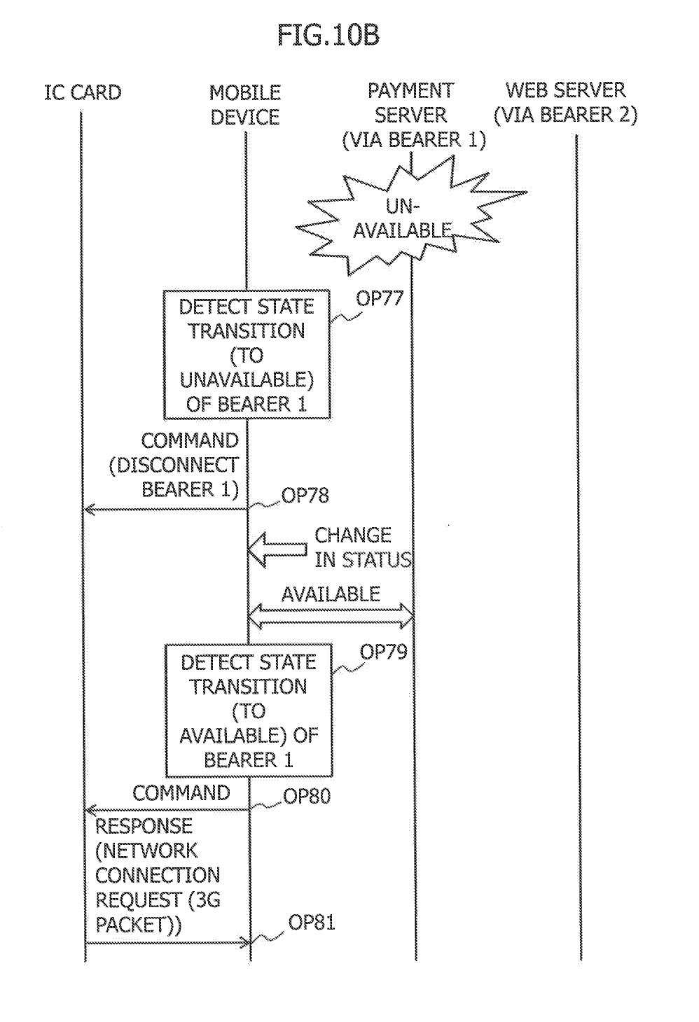

FIGS. 10A and 10B are an exemplary sequence of a process in Exemplary operation 3. The example illustrated in FIGS. 10A and 10B corresponds to the network system illustrated in FIG. 1, where the IC card 2 specifies in a connection request the bearer 1 as the network to connect to. FIG. A.10A and 10B illustrate a case where the mobile device 1 performs payment processing for purchase of a product provided by the Web server 3, as in the example illustrated in FIGS. 2A and 2B, for example. In the example illustrated in FIGS. 10A and 10B, the bearer 1 (3G network) and the bearer 2 (wireless LAN) are both available. The mobile device 1 has detected these states of the bearer 1 and the bearer 2. FIG. 10A omits actions relating to viewing of web pages from the mobile device 1 to the Web server 3, such as actions related to OP1 through OP3 in FIG. 2A. As actions at OP71 to OP74 of FIG. 10A are similar to OP31 to OP34 of Exemplary operation 1 illustrated in FIG. 8A, their descriptions are omitted.

In OP75, the mobile device 1 sends a connection request to the bearer 1 specified by the IC card 2 in the connection request. As the bearer 1 is available, connection is successfully established between the mobile device 1 and the bearer 1 (S2 in FIG. 7: Yes). In OP76, the mobile device 1 sends a notification of successful connection in a predetermined command to the IC card 2 (S3 in FIG. 7). Connection is established between the mobile device 1 and the IC card 2, and the IC card 2 communicates with the payment server 4.

Exemplary operation 3 assumes that during communication between the IC card 2 and the payment server 4, the state of the bearer specified in the connection request (bearer 1) by the IC card 2 transitions to unavailable as a result of, for example, the mobile device 1 moving outside the range (such as a tunnel). As a result, the connection between the mobile device 1 and the bearer 1 is terminated. In OP77, the network communication control unit 14 of the mobile device 1 detects the disconnection between the mobile device 1 and the bearer 1(S5 in FIG. 7: Yes). In OP78, the mobile device 1 sends a notification of disconnection of the bearer 1 in a predetermined command to the IC card 2 (S6 in FIG. 7).

Suppose that subsequently the bearer (3G network) transitions from unavailable to available as the mobile device 1 moves from outside to inside the range such as coming out of a tunnel, for example. In OP79, the mobile device 1 detects recovery of the bearer 1 (3G network) through the network communication control unit 14 (S7 in FIG. 7: Yes). Here, the decision unit 12 of the mobile device 1 compares the specified bearer stored in the storage unit 15 with the bearer that is detected to have recovered by the network communication control unit 14, and determines that they match.

In OP80, the mobile device 1 sends a predetermined command to the IC card 2 through the decision unit 12 because the specified bearer stored in the storage unit 15 and the bearer detected to have recovered by the network communication control unit 14 are both the bearer 1 (S8 in FIG. 7). The state of the specified bearer (i.e., available) may be included in the predetermined command.

In OP81, the IC card 2 receives the predetermined command from the mobile device 1. The IC card 2 sends through the card application unit 22 a network connection request that specifies the bearer 1 (3G network) as the response to the received command.

Thereafter, a connection is established between the mobile device 1 and the bearer 1 (S2 in FIG. 7: Yes) and a connection between the mobile device 1 and the IC card 2 is established, and communication between the IC card 2 and the payment server 4 is resumed, as in OP7 and the following operations in FIG. 2B and OP38 and the following operations in FIG. 8B.

In the first embodiment, the mobile device 1 sends a predetermined command to the IC card 2 even when the specified bearer becomes unavailable while the mobile device 1 is connected to the specified bearer and the connection is terminated, and the bearer recovers later, as in Exemplary operation 3. The first embodiment therefore enables the IC card 2 to resume communication using the specified bearer even in a case illustrated in Exemplary operation 3.

The timing of the mobile device 1 storing a connection request from the IC card 2 may be when a command containing a notification of failed connection to the bearer specified in the connection request is transmitted in OP35 in Exemplary operation 1 illustrated in FIG. 8A, for example.

The timing of the mobile device 1 deleting the connection request and the specified bearer stored in the storage unit 15 may be when connection with the recovered specified bearer is successfully established in Exemplary operation 1 illustrated in FIGS. 8A and 8B and Exemplary operation 2 illustrated in FIGS. 9A and 9B, for example. Alternatively, the timing of deleting the connection request and the specified bearer stored in the storage unit 15 may be when a predetermined time period has elapsed since they are stored in the storage unit 15 following transmission of a command for causing the IC card 2 to send a connection request after recovery of the specified bearer, for example.

### Advantageous Effects of the First Embodiment

In the first embodiment, the mobile device 1 stores a connection request from the IC card 2 and the specified bearer, detects transition of the specified bearer's state from unavailable to available, and sends a command to the IC card 2 in order to prompt the IC card 2 to resend the connection request. This enables an application in the IC card 2 to resend the connection request after the specified bearer recovers even when connection with the specified bearer fails or when communication connection with the bearer is terminated because the bearer is unavailable.

The information processing apparatus, information processing method, and information processing program disclosed herein enable connection to a network specified by a portable device which sends a connection request as a response to a command it receives, when communication over the specified network has transitioned from unavailable to available.

### Other

While the first embodiment illustrates a mobile device having an IC card, the present invention is not limited thereto; the invention is applicable to any information processing apparatus that uses BIP to perform communication with a portable device, such as a card. For example, the portable device may be an SD card instead of an IC card.

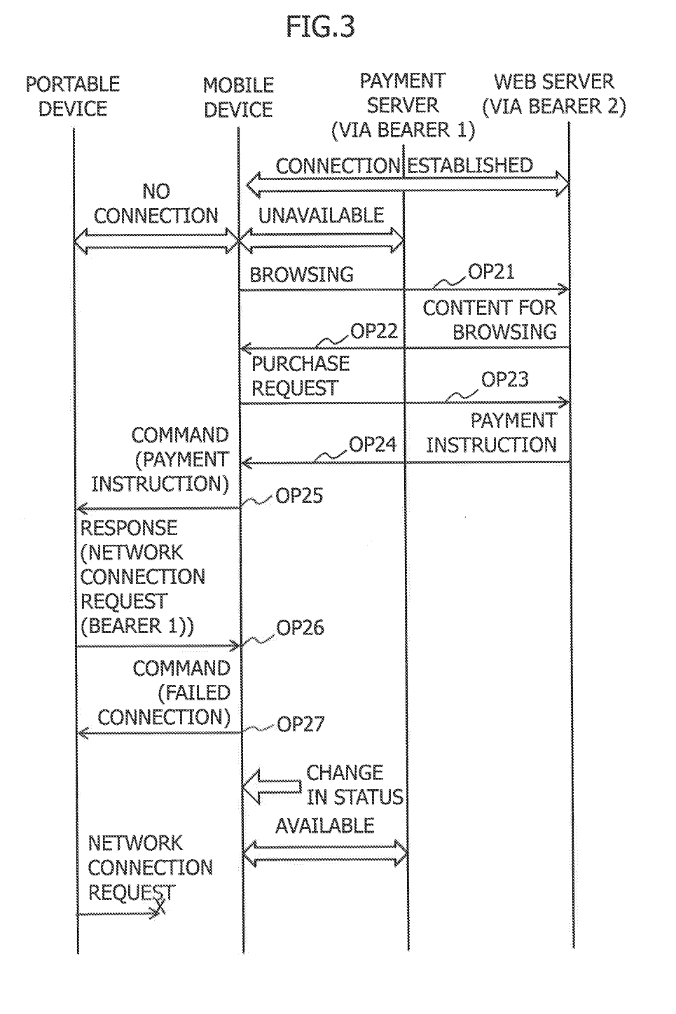

Also, while transmission of the command for payment instruction is initiated on the Web server 3 (such as in OP31 of FIG. 3) in the above-described first embodiment, this is not limitation. For example, the command for payment instruction may be sent from the mobile device 1 to the IC card 2 when the user inputs a purchase request, for example. In a case where the IC card 2 has browsing capability, browsing process involving the Web server 3 may also be done by the IC card 2 and payment processing may be initiated by the IC card 2 when the user inputs a purchase request through the mobile device 1. Additionally, notifications of payment instruction and completion from the Web server 3 may be SMS mail messages, for example.

In the first embodiment, when receiving a connection request from the IC card 2, the mobile device 1 stores the connection request and the specified bearer in the storage unit 15. When detecting recovery of a bearer, the mobile device 1 compares the recovered bearer with the specified bearer stored in the storage unit 15, and sends a predetermined command to the IC card 2 if they match. Instead of comparing the recovered bearer with the specified bearer, the mobile device 1 may send the predetermined command to the IC card 2 every time it detects a recovery of a bearer. When the application for issuing connection requests is not activated in the IC card 2, the predetermined command is discarded, for example. When the application for issuing connection requests is activated in the IC card 2, the IC card 2 sends a connection request in a response to the received command to the mobile device 1. When the bearer specified in the connection request matches the recovered bearer, connection to the specified bearer succeeds. When the bearer specified in the connection request and the recovered bearer do not match, connection to the specified bearer fails. When comparison between the recovered bearer and the specified bearer is not implemented, the connection request and the specified bearer do not have to be stored in the storage unit 15.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more the embodiments of the present invention have been described in detail, it should be understood that the various changes, substitutions, and alterations could be made hereto without departing from the spirit and scope of the invention.

What is claimed is:

1. An information processing apparatus comprising:
a processor;
a storage unit; and
a connection unit that connects to a portable device which sends a connection request for a predetermined network as a response to a command from the processor, wherein
the processor
stores the connection request from the portable device and the predetermined network contained in the connection request in the storage unit;
detects a state transition of communication over the predetermined network; and
determines whether a network whose status has transitioned from communication being unavailable to communication being available matches the predetermined network stored in the storage unit, and if the two networks match, sends a command to the portable device for causing the portable device to transmit a connection request for the predetermined network as a response.

2. An information processing method for an information processing apparatus comprising:
a processor;
a storage unit; and
a connection unit that connects to a portable device which sends a connection request for a predetermined network as a response to a command from the processor, wherein the information processing apparatus
storing the connection request from the portable device and the predetermined network contained in the connection request in the storage unit;
detecting a state transition of communication over the predetermined network; and
determining whether a network whose status has transitioned from communication being unavailable to communication being available matches the predetermined network stored in the storage unit, and if the two networks match, sending a command to the portable device for causing the portable device to transmit a connection request for the predetermined network as a response.

3. A non-transitory computer-readable recording medium having recorded therein an information processing program for causing an information processing apparatus comprising:
a processor;
a storage unit; and
a connection unit that connects to a portable device which sends a connection request for a predetermined network as a response to a command from the processor,
to store the connection request from the portable device and the predetermined network contained in the connection request in the storage unit;
detect a state transition of communication over the predetermined network; and
determine whether a network whose status has transitioned from communication being unavailable to communication being available matches the predetermined network stored in the storage unit, and if the two networks match, send a command to the portable device for causing the portable device to transmit a connection request for the predetermined network as a response.
